(19) United States
(12) Patent Application Publication
(10) Pub. No.: US 2026/0261881 A1
(43) Pub. Date: Sep. 3, 2026

(54) FUNCTION TESTING IN A COMMUNICATION NETWORK

(71) Applicant: Telefonaktiebolaget LM Ericsson (publ), Stockholm (SE)

(72) Inventors: Icaro Leonardo DA SILVA, Solna (SE); Szilveszter NÁDAS, Budapest (HU); Gunnar MILDH, Sollentuna (SE); Gergely PONGRÁCZ, Budapest (HU); Zoltán Richárd TURÁNYI, Szentendre (HU)

(21) Appl. No.: 18/875,240

(22) PCT Filed: Jun. 27, 2022
(86) PCT No.: PCT/EP2022/067591

§ 371 Date: Dec. 16, 2024

(51) Int. Cl. H04W 24/08; H04L 41/5009; H04W 8/18

(52) U.S. Cl. CPC H04W 24/08; H04L 41/5009; H04W 8/183

(57) ABSTRACT

A method is performed by a network slice control device for testing a function in a communication network. The communication network includes common resources for communication between a network node and user equipments, UEs. The function is associated with one or more of the UEs. The method includes deploying, for testing the function, first software in a first UE and second software in the network node. The method includes creating a first network slice. The method includes associating the first network slice with the first software and the second software. The method further includes associating the first network slice with third software, wherein the third software allocates common resources to the second software in a fair sharing manner.

### TECHNICAL FIELD

The present disclosure relates to function testing in a communication network. More specifically, the present disclosure relates to a UE, a network slice control device, and their corresponding methods, computer programs and computer program products.

### BACKGROUND

In Third Generation Partnership Project (3GPP) systems, such as Fifth Generation (5G) New Radio (NR) and Long Term Evolution (LTE), there are various protocols running on a network stack for communication between a User Equipment (UE) and the Radio Access Network (RAN) or Core Network (CN). The protocols are typically divided into i) Control Plane protocol for sending and receiving signaling, and ii) User Plane protocol for sending and receiving data.

The functions executed by these protocols are specified in the 3GPP specifications. Once the functions are specified, UE manufacturers implement them according to the 3GPP specifications so that a network equipment manufacturer may implement the corresponding functions in order to maintain operability between the UE and the network. However, the extent to which a network manufacturer may program or modify the UE behaviour is limited by the specifications implemented by the UE manufacturer. For example, a network equipment manufacturer may design a handover algorithm based on measurement events, for example A1-A6 events, defined in the 3GPP, under a certain configuration, and process measurement reports to take handover decision. But introduction of a new algorithm, a new trigger, and/or a new measurement report, would require standardization.

Recent initiatives in the area of Software Define Network (SDN) have introduced new mechanisms in the 5G Core Network, such as separation between Control Plane and User Plane functions, and open Application Programming Interface (API) that may be used by a third party in order to program control functions. Further, virtualization and cloud technologies may be used to program the API(s) on the network side.

In the RAN domain, initiatives in the area of RAN programmability to open API(s) on the network side are quite limited. Further, the benefits of such initiatives are limited to UE capabilities in a given version of the 3GPP specifications. In other words, while a programmer benefiting from the possibly open API could in theory design a new scheduling algorithm, the programmer may not be able to implement the type of information a UE reports, or some specific behavior the program intends the UE to perform upon receiving a given command, due to standardization requirements. Additionally, even if UE behavior is updated in the Standard, network vendors must support legacy behavior for a long period. This makes network design complex with newer generations of mobile network.

In the Information and Communication Technology (ICT) industry, software developers typically release a new version of software to just a subset of users or systems. By enabling new software within a subset of the user base, developers or system administrators may monitor any issues arising due to the new software deployment without causing major disruption to the entire user base.

In the telecom industry, firstly, functions related to UE programmability are not currently deployed. Secondly, deploying, in telecom, a software deployment mechanism similar to ICT, is challenging due to complex networks, interoperability issues and requirement of legacy support. Furthermore, the existing software deployments to a subset of end-device users or end-devices do not take into account network Key Performance Index or Key Performance Indicator (KPI), which are needed to make a fair assessment regarding full-scale deployment of the deployed software to a selective set of end-device users or end-devices.

### SUMMARY

An object of at least some embodiments disclosed herein is to facilitate programmability in a communication network.

Another object of at least some embodiments disclosed herein is to facilitate testing of one or more functions in a communication network.

To achieve one or more of these objects, according to a first aspect, there is provided a method performed by a network slice control device for testing a function in a communication network. The communication network comprises common resources for communication between a network node and user equipments (UEs). The function is associated with one or more of the UEs. The method comprises:
deploying, for testing the function, first software in a first UE and second software in the network node;
creating a first network slice;
associating the first network slice with the first software and the second software; and
associating the first network slice with third software, wherein the third software allocates common resources to the second software in a fair sharing manner.

In an embodiment according to the first aspect, the method further comprises:
creating a second network slice;
associating the second network slice with fourth software and a second UE; and
associating the second network slice with the third software, wherein the third software allocates common resources between the second software and the fourth software in a fair sharing manner.

In an embodiment according to the above embodiment, the method further comprises collecting key performance index, KPI, data from the first UE and the second UE.

In an embodiment according to the above embodiment, the KPI data includes at least one of: latency, round-trip time, throughput, signal strength(s) and radio resource utilization.

In an embodiment according to any one of the above embodiments, deploying the first software includes sending a new instance of a network stack or configuring an existing instance of a network stack, wherein the network stack includes the function to be tested.

In an embodiment according to any one of the above embodiments, the function includes at least one of: packet scheduling, radio slot allocation, cell selection, quality of service enforcement, routing, packet inspection and service identification.

In an embodiment according to any one of the above embodiments, the deploying of the first software is carried out using Over-The-Air software update.

In an embodiment according to any one of the above embodiments, the method further comprises testing the function, wherein the testing includes:
obtaining a KPI, for the first UE and a KPI for the second UE; and
evaluating performance of the first software based on the obtained KPIs.

In an embodiment according to the above embodiment, the evaluating performance of the first software comprises evaluating performance of the function.

In an embodiment according to any one of the above embodiments, the third software is a radio scheduler that allocates common resources between the second software and fourth software in a fair sharing manner, wherein the second software is a radio scheduler for scheduling radio resources for testing the function and the fourth software is a radio scheduler pre-configured to schedule radio resources for a second UE.

In an embodiment according to any one of the above embodiments, the fair sharing of the common resources is performed using Weighted Fair Queuing, WFQ.

In an embodiment according to any one of the above embodiments, the common resources comprise at least one of the radio resources: resource block, bandwidth and frequency.

In an embodiment according to any one of the above embodiments, the common resources comprise at least one of: a computing resource, a network resource and a storage resource.

According to a second aspect, there is provided a method performed by a first user equipment (UE) for testing a function in a communication network. The communication network comprises common resources for communication between a network node and UEs. The function is associated with one or more of the UEs The method comprises:
receiving first software from the network node; and
receiving an association to a first network slice, wherein the first network slice associates the first software and second software deployed in the network node, wherein the first network slice is further associated with third software, and wherein the third software allocates common resources to the second software in a fair sharing manner.

In an embodiment according to the second aspect, the receiving the first software comprises:
receiving a new instance of a network stack; or
being configured with an existing instance of a network stack, wherein the network stack includes the function to be tested.

In an embodiment according to any one of the above embodiments according to the second aspect, the function includes at least one of: packet scheduling, radio slot allocation, cell selection, quality of service enforcement, routing, packet inspection and service identification.

In an embodiment according to any one of the above embodiments according to the second aspect, the method comprises sending, to the network node, key performance index, KPI, data associated with the first UE that is using the first software.

In an embodiment according to the above embodiment according to the second aspect, the KPI data includes at least one of: latency, round-trip time, throughput, signal strength and radio resource utilization.

In an embodiment according to any one of the above embodiments according to the second aspect, the first software is received using Over-The-Air software update.

In an embodiment according to any one of the above embodiments according to the second aspect, the first software is a network stack for testing the function.

In an embodiment according to any one of the above embodiments according to the second aspect, the method further comprises sending, from the first UE to the network node, at least one KPI for evaluating performance of the first software.

In an embodiment according to any one of the above embodiments according to the second aspect, the third software is a radio scheduler that allocates common resources between the second software and fourth software in a fair sharing manner, the second software is a radio scheduler for scheduling radio resources for testing the function, and the fourth software is a radio scheduler pre-configured to schedule radio resources for a second UE.

In an embodiment according to any one of the above embodiments according to the second aspect, the fair sharing of the common resources is performed using Weighted Fair Queuing, WFQ.

In an embodiment according to any one of the above embodiments according to the second aspect, the common resources comprise at least one of the radio resources: resource block, bandwidth and frequency.

In an embodiment according to any one of the above embodiments according to the second aspect, the common resources comprise at least one of: a computing resource, a network resource and a storage resource.

According to a third aspect, there is provided a network slice control device for testing a function in a communication network. The communication network comprises common resources for communication between a network node and user equipments (UEs). The function is associated with one or more of the UEs. The network slice control device comprises a memory and a processor. The memory contains instructions which when executed on the processor cause the network slice control device to:
deploy, for testing the function, first software in a first UE and second software in the network node;
create a first network slice;
associate the first network slice with the first software and the second software; and
associate the first network slice with third software, wherein the third software allocates common resources to the second software in a fair sharing manner.

In an embodiment according to the third aspect, the memory contains instructions which when executed on the processor cause the network slice control device to:
create a second network slice;
associate the second network slice with fourth software and a second UE; and
associate the second network slice with the third software, wherein the third software allocates common resources between the second software and the fourth software in a fair sharing manner.

In an embodiment according to the above embodiment according to the third aspect, the memory contains instructions which when executed on the processor cause the network slice control device to collect key performance index, KPI, data from the first UE and the second UE.

In an embodiment according to any one of the above embodiments according to the third aspect, the KPI data includes at least one of: latency, round-trip time, throughput, signal strength(s) and radio resource utilization.

In an embodiment according to any one of the above embodiments according to the third aspect, the memory contains instructions which when executed on the processor cause the network slice control device to deploy the first software by sending a new instance of a network stack or configuring an existing instance of a network stack, wherein the network stack includes the function to be tested.

In an embodiment according to any one of the above embodiments according to the third aspect, the function includes at least one of: packet scheduling, radio slot allocation, cell selection, quality of service enforcement, routing, packet inspection and service identification.

In an embodiment according to any one of the above embodiments according to the third aspect, the memory contains instructions which when executed on the processor cause the network slice control device to deploy the first software using Over-The-Air software update.

In an embodiment according to any one of the above embodiments according to the third aspect, the memory contains instructions which when executed on the processor cause the network slice control device to test by:
obtaining a KPI for the first UE and a KPI for the second UE; and
evaluating performance of the first software based on the obtained KPIs.

In an embodiment according to the above embodiment according to the third aspect, evaluating performance of the first software comprises evaluating performance of the function.

In an embodiment according to any one of the above embodiments according to the third aspect, the third software is a radio scheduler configured to allocate common resources between the second software and fourth software in a fair sharing manner, the second software is a radio scheduler configured to schedule radio resources for testing the function, and the fourth software is a radio scheduler pre-configured to schedule radio resources for a second UE.

In an embodiment according to any one of the above embodiments according to the third aspect, the memory contains instructions which when executed on the processor cause the network slice control device to perform fair sharing of the common resources using Weighted Fair Queuing, WFQ.

In an embodiment according to any one of the above embodiments according to the third aspect, the common resources comprise at least one of the radio resources: resource block, bandwidth and frequency.

In an embodiment according to any one of the above embodiments according to the third aspect, the common resources comprise at least one of: a computing resource, a network resource and a storage resource.

According to a fourth aspect, there is provided a first user equipment (UE) for testing a function in a communication network. The communication network comprises common resources for communication between a network node and UEs. The function is associated with one or more of the UEs. The first UE comprises a memory and a processor. The memory contains instructions which when executed on the processor cause the first UE to:
receive first software from the network node; and
receive an association to a first network slice, wherein the first network slice associates the first software and second software deployed in the network node, wherein the first network slice is further associated with third software, and wherein the third software allocates common resources to the second software in a fair sharing manner.

In an embodiment according to the fourth aspect, the memory contains instructions which when executed on the processor cause the first UE to receive by:
receiving a new instance of a network stack; or
being configured with an existing instance of a network stack, wherein the network stack includes the function to be tested.

In an embodiment according to any one of the above embodiments according to the fourth aspect, the function includes at least one of: packet scheduling, radio slot allocation, cell selection, quality of service enforcement, routing, packet inspection and service identification.

In an embodiment according to any one of the above embodiments according to the fourth aspect, the memory contains instructions which when executed on the processor cause the first UE to send, to the network node, key performance index, KPI, data associated with the first UE that is using the first software.

In an embodiment according to the above embodiment according to the fourth aspect, the KPI data includes at least one of: latency, round-trip time, throughput, signal strength and radio resource utilization.

In an embodiment according to any one of the above embodiments according to the fourth aspect, the memory contains instructions which when executed on the processor cause the first UE to receive the first software using Over-The-Air software update.

In an embodiment according to any one of the above embodiments according to the fourth aspect, the first software is a network stack for testing the function.

In an embodiment according to any one of the above embodiments according to the fourth aspect, the memory contains instructions which when executed on the processor cause the first UE to further send, from the first UE to the network node, at least one KPI for evaluating performance of the first software.

In an embodiment according to any one of the above embodiments according to the fourth aspect, the third software is a radio scheduler configured to allocate common resources between the second software and fourth software in a fair sharing manner, the second software is a radio scheduler configured to schedule radio resources for testing the function, and the fourth software is a radio scheduler pre-configured to schedule radio resources for a second UE.

In an embodiment according to any one of the above embodiments according to the fourth aspect, the memory contains instructions which when executed on the processor cause the first UE to perform the fair sharing of the common resources using Weighted Fair Queuing, WFQ.

In an embodiment according to any one of the above embodiments according to the fourth aspect, the common resources comprise at least one of the radio resources: resource block, bandwidth and frequency.

In an embodiment according to any one of the above embodiments according to the fourth aspect, the common resources comprise at least one of: a computing resource, a network resource and a storage resource.

According to a fifth aspect there is provided a computer program, comprising instructions which, when executed on a network slice control device, cause the network slice control device to carry out the method according to any of the embodiments according to the first aspect.

According to a sixth aspect there is provided a carrier containing the computer program according to the fifth aspect, wherein the carrier is one of an electronic signal, optical signal, radio signal, or computer-readable storage medium.

According to a seventh aspect there is provided a computer program product comprising a computer readable storage means on which the computer program according to the fifth aspect is stored.

According to an eighth aspect there is provided a computer program comprising instructions which, when executed on a first UE, cause the first UE to carry out the method according to any of the embodiments according to the second aspect.

According to a ninth aspect there is provided a carrier containing the computer program according to the eighth aspect, wherein the carrier is one of an electronic signal, optical signal, radio signal, or computer-readable storage medium.

According to a tenth aspect there is provided a computer program product, comprising a computer readable storage means on which the computer program according to the eighth aspect is stored.

At least some embodiments of the present disclosure provide a capability of programming one or more UEs with a custom network stack enabling testing one or more functions in a communication network.

At least some embodiments of the present disclosure enable a mechanism to test out one or more functions within a set of UEs in a network without impacting the functioning of other UEs in the network.

At least some embodiments of the present disclosure provide a mechanism for safeguarding the operation of one or more UEs in a communication network while updating one or more network stacks in the communication network.

### BRIEF DESCRIPTION OF THE DRAWINGS

FIG. 1 illustrates a system according to an embodiment.

FIG. 1a illustrates a system according to an embodiment.

FIG. 2 illustrates a user plane network stack according to an embodiment.

FIG. 3 illustrates a control plane network stack according to an embodiment.

FIG. 4 illustrates a flowchart according to an embodiment.

FIG. 5 illustrates a method performed by a network slice control device according to an embodiment.

FIG. 6 illustrates a method performed by a first UE according to an embodiment.

FIG. 7 illustrates a system according to an embodiment.

FIG. 8 illustrates a network slice control device according to an embodiment.

FIG. 9 illustrates a first UE according to an embodiment.

FIG. 10 illustrates a network slice control device according to an embodiment.

FIG. 11 illustrates a first UE according to an embodiment.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

The following terms are used throughout the present disclosure:
network slice (NS): a logical network that provides specific network capabilities and network characteristics, supporting various service properties for network slice customers. A NetworkSlice Information Object Class (IOC), as defined in for example 3GPP TS 28.541 V17.6.0 (2022 Mar. 22), may be used to model a network slice.
network slice instance (NSI): A Managed Object Instance (MOI) of Network Slice IOC. The Network Slice instance represents service view of a network slice which exposes the root NetworkSliceSubnet instance.

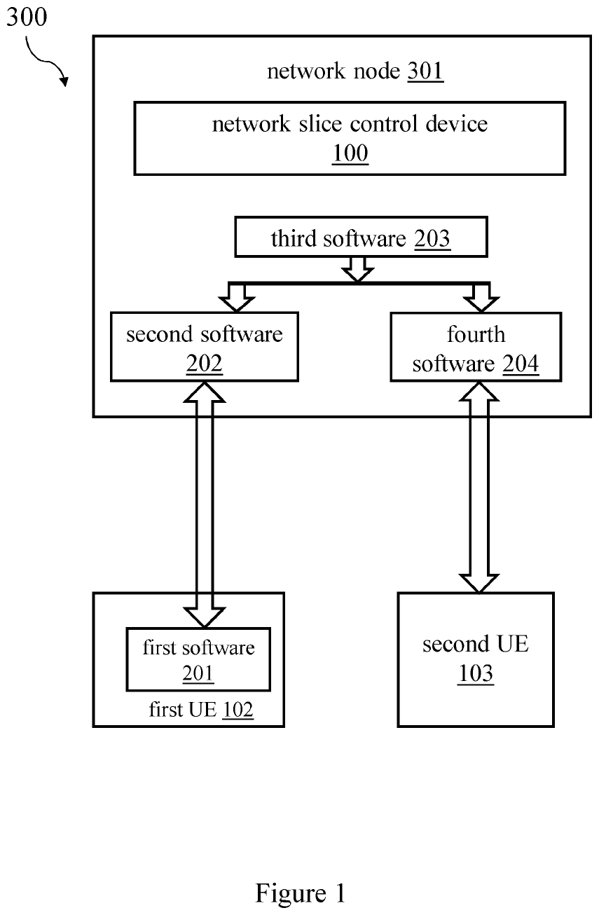

FIG. 1 illustrates a system 300 according to an embodiment. The system 300 comprises a network node 301, a first user equipment (UE) 102 and a second UE 103. The network node 301 comprises a network slice control device 100. The first UE 102 employs first software 201, and the network node 301 employs second software 202, third software 203 and fourth software 204. Software may be a computer program, or part of a computer program, or instructions/code/settings that can be used as part of a computer program. Software may also refer to firmware, such as firmware of the first UE 102 or of the network node 301.

Referring to FIG. 1, there is disclosed a mechanism for making a UE (such as the first UE 102) and other network components (such as the network node 301) programmable. The network slice control device 100 deploys software in the first UE 102 and in the network node 301. The deployed software may, for example, be a network stack. It is desired to gradually introduce software in existing communication networks and test the software in a live environment with real users without impacting the functioning of other UEs in the network. To that extent, the network slice control device 100 deploys the first software 201 only to the first UE 102 while the second UE 103 runs legacy software (such as a legacy network stack). Legacy software (such as a legacy network stack) may refer to any software running and/or executing one or more features according to a release of a standard, for example NR Release 16 of 3GPP. To enable the first UE 102 to interact with the network node 301 and the first software 201, a corresponding software/network stack (referred to herein as second software 202), is deployed in the network node 301. Similarly, the legacy software/legacy network stack of the second UE 103 also has a corresponding software/network stack (referred to herein as fourth software 204) comprised in the network node 301. Network slicing methods are used to associate a network slice with the first software 201 and the second software 202 and to associate another network slice with the fourth software 204 and the legacy software in the second UE 103. To enable a fair assessment of the functioning of the first UE 102 comprising the first software 201 with the second UE 103 comprising the legacy software, third software 203 is deployed in the network node 301. The third software 203 is further associated with the network slices of both the second software 202 and the fourth software 204. The third software 203 schedules one or more common resources to the second software 202 and the fourth software 204 or their corresponding network slices in a fair manner. In other words, the third software 203 ensures that resource allocation to both of these software is carried out in a manner that does not impact the outcome of a testing to be carried out in the communication network. For example, the network slice control device 100 may test out the performance of a function comprised in the deployed first software 201/network stack (in other words, at the first UE 102) and compare the performance of that function with the performance of the legacy software used at the second UE 103. In such a case, it is crucial that the resource allocation to the network slice associated with the second software 202 and the first software 201, and the network slice associated with the fourth software 204 and the legacy software in the second UE 103, is carried out in such a way as to not provide an unfair performance advantage for the function-testing UE (the first UE 102) over the legacy UE (the second UE 103), or vice versa. Finally, testing of the function is carried out by the network slice control device 100 by obtaining KPI data from the first UE 102 and the second UE 103 and evaluating the performance of the deployed first software 201 in the first UE 102. With the approach described with reference to FIG. 1 it is possible to test out new or upgraded features of key mobile network components such as a UE and a network node, on production networks with real users and traffic while supporting mobile network operator (MNO) requirements.

It will be appreciated that the various features described in relation to FIG. 1 may, for example, be used for:
simplification of network slice deployment leading to reduced performance overhead;
deployment of network stack via simple software upgrades;
enabling programmability of UEs and network nodes without requiring to support new standard release; and
easy deployment of new firmware or new software versions for UEs in existing network and testing functions in live environment with real users and traffic while still supporting legal requirements and mobile network operator requirements.

It will be appreciated that various modifications or variations of the embodiment described with reference to FIG. 1 are possible. Some such modifications or variations are illustrated in FIG. 1a.

In FIG. 1, the network slice control device 100 is comprised in the network node 301 rather than being separate from the network node 301. As shown in FIG. 1a, the network slice control device 100 need not necessarily be comprised in the network node 301. For example, the network slice control device 100 may be comprised in a different node than the network node 301 comprising the second software 202, the third software 203 and the fourth software 204.

As shown in FIG. 1a, the first UE 102 may be operating in a first communication network 111 while the second UE 102 may be operating in a second communication network 112. However, the first UE 102 and the second UE 103 both operate in the same communication network 110.

As shown in FIG. 1a, the system 300 may, for example, comprise one or more additional UEs analogous to the first UE 102. Together with the first UE 101, these additional UEs may for example be referred to as first UEs 102. Similarly, the system 300 may for example comprise one or more additional UEs analogous to the second UE 103. Together with the second UE 103 these additional UEs may for example be referred to as second UEs 103.

As shown in FIG. 1a, the network node 301 may for example be a base station (BS) 101 or a gNodeB (gNB) 104.

Referring to FIG. 1 and FIG. 1a, in some embodiments, the communication network 110, the first communication network 111, and/or the second communication network 112 may be a radio communication network, such as a 5G/New Radio (NR) network. Although, the communication networks 110,111,112 are exemplified herein as an 5G/NR network, the communication network 110, 111, and/or 112 may also employ technology of any of Sixth Generation (6G), Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), Ultra Mobile Broadband (UMB) or GSM, or any other similar network or system. The communication network 110, 111 and/or 112 may also be an Ultra Dense Network (UDN) which for example may transmit on millimetre-waves (mmW). The communication network 110, the first communication network 111, and/or the second communication network 112 may, thus, be a wireless communication network. The communication network 110, 111, 112 may comprise one or more of the following: at least one first UE 102, at least one second UE 103, the network slice control device 100, and the network node 301.

The network node 301 may correspond to a node such as a radio network node or a core network node or a transport network node capable of communicating with one or more UEs and/or with another node. Examples of such a network node 301 in the radio access network (RAN) may be a BS 101, a radio base station, gNB 304, eNB, eNodeB, a Home Node B, a Home eNode B, femto Base Station (BS), pico BS, etc., for example located in the communication network 110, 111, or 112. Further examples of the network node 301 may also be user plane function (UPF) node, access and mobility management function (AMF) node, etc. Further examples of the network node 301 may also be for example repeater, base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, a Remote Radio Unit (RRU), a Remote Radio Head (RRH), nodes in distributed antenna system (DAS), core network node (for example MSC, MME, etc.), operation and management (O&M) node, Operations Support System (OSS) node, Self-Organizing Network (SON) node, switch router, fronthaul node, backhaul node etc.

A UE, such as the first UE 102 and/or the second UE 103, may be a wireless device, a wireless communication device, or a wireless communication terminal. The UE may be configured to provide wireless communication according to one or more embodiments.

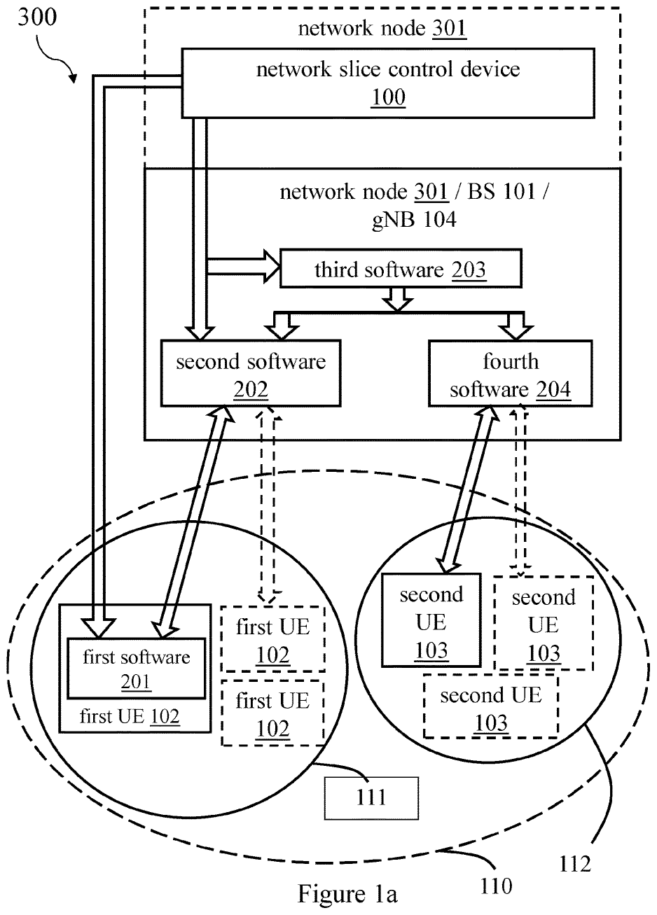

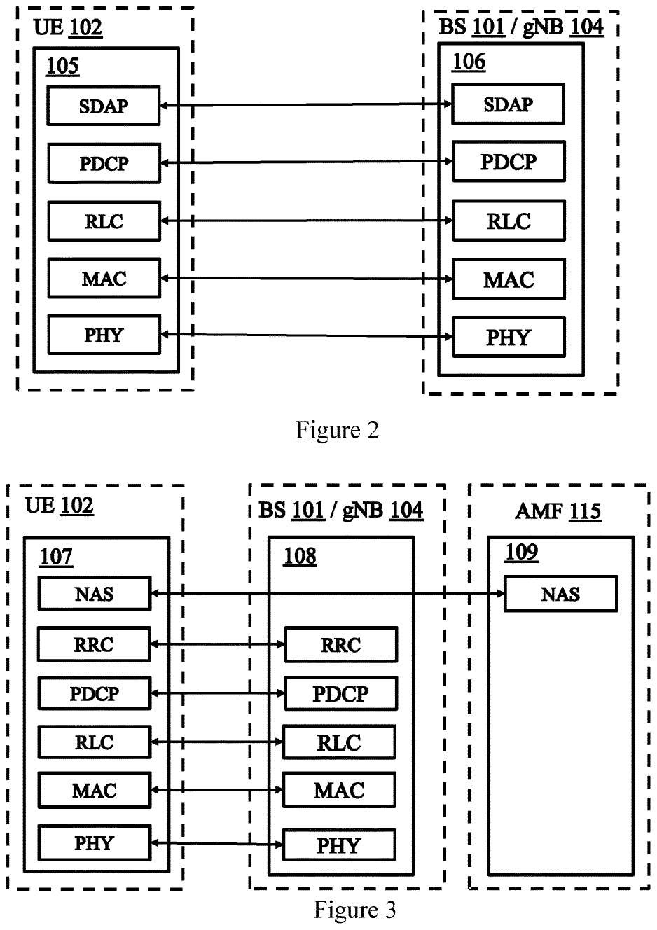

FIG. 2 illustrates a network stack for a user plane (UP) for, for example, the first UE 102, and a network stack for UP for a Radio Access Network (RAN) node, for example, a Base station (BS) 101 such as a gNodeB (gNB) 104. The network stack for UP for a UE is herein referred to as UE UP network stack 105. The network stack for UP for a RAN node is herein referred to as BS UP network stack 106. The UE UP network stack 105 comprises software of one or more logical layers of communication networking namely Physical (PHY), Medium Access Control (MAC), Radio Link Control (RLC), Packet Data Convergence Protocol (PDCP) and Service Data Adaption Protocol (SDAP). The communication is terminated in the corresponding network stack on the network side, for example a BS UP network stack 106. The BS 101 and/or the gNB 104 may comprise software of one or more logical layers of communication networking namely a PHY, a MAC, a RLC, a PDCP and a SDAP.

FIG. 3 illustrates a network stack for the control plane (CP) for a UE 102, a RAN node or a BS 101 such as the gNB 104, and a Core Network (CN) node such as the Access and Mobility Function (AMF) 115. The UE CP network stack 107 of a UE for example the first UE 102 comprises software of one or more logical layers of communication networking namely PHY, MAC, RLC, PDCP, Radio Resource Control (RRC) and Non-Access Stratum (NAS). The BS CP network stack 108 of the BS 101 or of the gNB 104, comprises software of one or more logical layers of communication networking namely PHY, MAC, RLC, PDCP, and RRC.

NAS control protocol terminates in the core network control plane network stack 109, herein referred to as CN CP network stack 109, for example the AMF CP network stack, on the network side. The NAS protocol performs the functions listed, for example, in 3GPP TS 23.501 v17.4.0 (2022 Mar. 23), for instance: authentication, mobility management, security control.

Referring to FIG. 2 and FIG. 3, the PHY layer of at least one of: the UE UP network stack 105, the UE CP network stack 107, the BS UP network stack 106 and the BS CP network stack 108, perform one or more of the following functions:
Error detection on the transport channel and indication to higher communication layers of the network stack;
Forward Error Correction (FEC) encoding/decoding of the transport channel;
Hybrid Automatic Repeat Request (ARQ) soft-combining;
Rate matching of the coded transport channel to physical channels;
Mapping of the coded transport channel onto physical channels;
Power weighting of physical channels;
Modulation and demodulation of physical channels;
Frequency and time synchronisation;
Radio characteristics measurements and indication to higher communication layers;
Multiple Input Multiple Output (MIMO) antenna processing;
Radio Frequency (RF) processing.

Referring to FIG. 2 and FIG. 3, the MAC layer of at least one of: the UE UP network stack 105, the UE CP network stack 107, the BS UP network stack 106 and the BS CP network stack 108, perform one or more of the following functions:
time-critical functions including functions with stringent delay requirements, e.g. HARQ
functions where performance is proportional to latency (e.g. radio channel and signal measurements from PHY, random access control);
reducing delay requirements on the fronthaul interface;
centralized scheduling to control other multiple MAC sublayers;
high-level centralized scheduling decision;
inter-cell interference coordination; and
radio-scheduling related processing and reporting.

The PDCP and the RLC communication layers are responsible for providing one or more transport functions.

The RRC and the NAS communication layers are responsible for providing radio link setup and maintenance.

The UE UP network stack 105 and/or the UE CP network stack 107 perform one or more functions related to radio link setup and maintenance. In case of the UE CP network stack 107, the functions may be performed in at least one of the RRC and NAS communication layers.

One or more of the following RRC layer services are received from the communication layers below RRC layer in at least one of: the UE UP network stack 105, the UE CP network stack 107, the BS UP network stack 106 and/or the BS CP network stack 108:

### Integrity Protection;

Ciphering;
Loss-less in-sequence delivery of information without duplication.

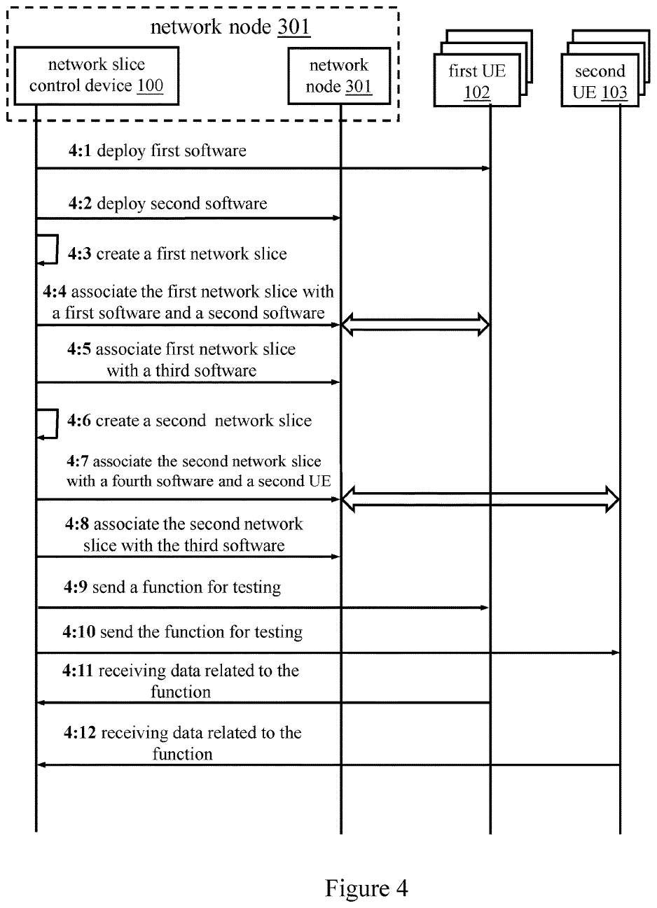

FIG. 4 illustrates a flow chart depicting message exchanges between one or more entities of the system 300 according to an embodiment. A detailed explanation is provided below for the procedure summarized above in relation to FIGS. 1 and 1a.

### Step 4:1—Deploy a First Software

As illustrated, a first software 201 is deployed by the network slice control device 100 in at least one first UE 102. The first software 201 may, for example, be a lightweight software with minimum capabilities to perform one or more functions of the logical layers of communication. Deploy may, for example, refer to sending a piece of code or software to a client that the client may download and execute. For example, deploy may include pushing system updates, e.g. similar to Android system updates, to a UE. As another example, deploy may include performing an operation similar to pushing Windows or Ubuntu updates to a computer.

Deploy procedure may typically employ Transmission Control Protocol and the Internet Protocol (TCP/IP) based protocols where a client checks for updates periodically. So, for a UE, e.g. the first UE 102, initially a basic connection may be set up with minimal functionality and then the basic connection may be used for checking for updates.

In an embodiment, the first software 201 is deployed to some of the UEs in a communication network, e.g the communication network 110.

In an embodiment, the first software 201 is deployed to all UEs in the communication network, for example the communication network 111.

In an embodiment, the first software 201 is configurable in that one or more functions comprised in the first software 201 may be added or removed.

In an embodiment, the first software 201 comprises one or more software versions or network stack instances for the first software 201.

In an embodiment, the network slice control device 100 includes an indication of the software version or the network stack instance to be used for testing one or more functions in the first UE 102. In some embodiments, such an indication is included during the deploying of the first software 201 for example in the same message as the message comprising the Over-The-Air (OTA) update. In some other embodiments, such an indication is sent to the first UE 102 in a separate message after deploying the first software 201.

The network slice control device 100 may send one or more messages to the UE, e.g. the first UE 102, using or re-using, for example, apt command framework from Ubuntu or any other mobile-specific OTA mechanism.

In an embodiment, the first software 201 comprises a network stack for the first UE 102. The network stack may, for example, be the UE UP network stack 105 and/or the UE CP network stack 107. The first software 201 comprising the network stack may for example perform one or more functions of the UE UP network stack 105 and/or the UE CP network stack 107 described above in relation to FIG. 2 and/or FIG. 3.

In an embodiment, the UE UP network stack 105 and/or the UE CP network stack 107 performs one or more functions related to transport. More specifically, the one or more functions related to transport are performed in the RLC layer and/or the PDCP layer of the network stacks.

In an embodiment, the UE UP network stack 105 and/or the UE CP network stack 107 performs one or more functions related to multi-link function. The multi-link function may include at least one of Carrier Aggregation (CA), Dual Connectivity (DC) and Access Traffic Steering, Switching and Splitting (ATSSS).

In an embodiment, the UE UP network stack 105 and/or the UE CP network stack 107 performs one or more functions related to uplink packet queues and scheduling.

In an embodiment, the UE UP network stack 105 and/or the UE CP network stack 107 performs one or more functions related to egress Quality of Service (QoS) handling, for example priorities. That is, the function related to egress Quality of Service (QoS) handling may, for example, be to set a Differentiated Service Code Point (DSCP) field or a Type of Service (ToS) field in the IP header. The function may, for example, be to apply an Active Queue Management (AQM) technique. The function may, for example, be to classify traffic according to a service type.

In an embodiment, the first software 201 comprising the network stack performs at least one of the following functions: packet scheduling, radio slot allocation, cell selection, quality of service enforcement, routing, packet inspection and service identification. The functions may be those for which testing is to be carried out in the communication network 110, 111.

In an embodiment, deploying the first software 201 includes sending a new instance of a network stack or configuring an existing instance of a network stack. Configuring an existing instance of a network stack may, for example, include adding or removing one or more functions to/from the network stack.

In an embodiment, the first software is deployed using OTA update. The OTA update procedure may, for example, be similar to an Operating System (OS) update over-the-air or application updates over-the-air.

### Step 4:2—Deploy a Second Software

As illustrated, the network slice control device 100 deploys a second software 202 in the network node 301. In an embodiment, the network slice control device 100 deploys the second software 202 by installing and/or executing the second software 202 in the network node 301.

Deploy may, for example, refer to sending a piece of code or software to a client that the client may download and execute. For example, deploy may include pushing system updates, e.g. Android system updates, to a UE. As another example, deploy may include performing an operation similar to pushing Windows or Ubuntu updates to a computer.

Deploy procedure may typically employ Transmission Control Protocol and the Internet Protocol (TCP/IP) based protocols where a client checks for updates periodically. So, for the first network node 301 first a basic connection may be set up with minimal functionality and then the basic connection may be used for checking for updates.

In an embodiment, the network slice control device 100 deploys the second software 202 by including an indication of the software version or the network stack that is to be installed and/or used in the network node 301. In some embodiments, such an indication is included during the deploying of at least one software version of the second software 202. In some other embodiments, such an indication is sent to the network node 301 in a separate message to indicate the correct software version of the second software to be used for installation and/or execution, wherein at least one software version of the second software 202 has previously been deployed. In such embodiments, the network slice control device 100 and the second software 202 are comprised in two separate network nodes.

The network slice control device 100 may send one or more messages to the network node 301 using or re-using, for example, apt command framework from Ubuntu or any other mobile-specific OTA mechanism.

In an embodiment, the network slice control device 100 and the second software 202 are comprised in the same network node 301, in which case, the deploying refers to a local installation of the second software 202.

In an embodiment, the network node 301 is a gNB 104.

In an embodiment, the second software 202 is configurable wherein one or more functions comprised in the second software 202 may be added or removed.

In an embodiment, the second software 202 comprises one or more software versions or network stack instances for the second software 202.

In an embodiment, the second software 202 comprises a network stack for the network node 301. The network stack may, for example, be at least one of: the BS UP network stack 106, the BS CP network stack 108 and the CN CP network stack 109. The second software 202 comprising the network stack for the network node 301 may perform one or more functions of the BS UP network stack 106 and/or the BS CP network stack 108 and/or the CN CP network stack 109 described above in relation to FIG. 2 and/or FIG. 3.

In an embodiment, the BS UP network stack 106 and/or the BS CP network stack 108 performs at least one function related to RRC, herein referred to as RRC functions. More specifically, the RRC functions are performed in the RRC layer. The RRC functions include one or more of the functions described above in relation to RRC layer protocol and/or RRC layer services.

In an embodiment, the BS UP network stack 106 and/or the BS CP network stack 108 performs at least one function related to transport protocols, herein referred to as transport functions. More specifically, the transport functions are performed in the RLC and/or PDCP communication layers of the network stacks.

In an embodiment, the BS UP network stack 106 and/or the BS CP network stack 108 performs one or more functions related to downlink packet queues and scheduling.

In an embodiment, the BS UP network stack 106 and/or the BS CP network stack 108 performs one or more functions related to QoS handling.

In an embodiment, the BS UP network stack 106 and/or the BS CP network stack 108 perform as a proxy between the UE (for example the first UE 102) and a core network node (for example the AMF 115).

In an embodiment, the BS UP network stack 106 and/or the BS CP network stack 108 performs one or more functions related to mobility handling.

In an embodiment, the CN CP network stack 109 performs one or more functions related to routing.

In an embodiment, the CN CP network stack 109 performs one or more functions related to firewall and/or packet filtering.

In an embodiment, the CN CP network stack 109 performs one or more functions related to service detection.

In an embodiment, the CN CP network stack 109 performs one or more functions related to QoS handling.

In an embodiment, the CN CP network stack 109 performs one or more functions related to charging data collection.

In an embodiment, the CN CP network stack 109 stack performs one or more functions related to downlink packet queues and scheduling.

In an embodiment, the second software 202 comprising the network stack for the network node 301 performs at least one of the following functions: packet scheduling, radio slot allocation, cell selection, quality of service enforcement, routing, packet inspection and service identification. The functions may be those for which testing is to be carried out in the communication network 110, 111.

In an embodiment, deploying the second software 202 includes sending a new instance of the network stack for the network node 301 or configuring an existing instance of the network stack of the network node 301. Configuring an existing instance of the network stack may, for example, include adding or removing one or more functions to/from the network stack.

### Step 4:3—Create a First Network Slice

The network slice control device 100 creates a first network slice. The principles of network slicing are described later in the application under the section “Network slicing concepts”.

In an embodiment, the network slice control device 100 creates a network slice, for example the first network slice and/or the second network slice, by employing one or more of the following techniques:
Network function (NF): NFs define elementary network functionalities that are used as building blocks to create a network slice.
Virtualization: It provides a representation of the physical resources under a unified and homogeneous scheme. This method enables a scalable network slice deployment relying on Network Function Virtualization (NFV) that allows the decoupling of each network function instance from the network hardware it runs on.
Orchestration: It is a method that allows coordination of all the different network components that are involved in the life-cycle of each network slice. In this context, Software Defined Networking (SDN) is employed to enable a dynamic and flexible slice configuration.

In an embodiment, the network slice control device 100 creates the network slice, e.g. the first network slice and/or the second network slice, in the RAN part of the network.

In an embodiment, the network slice control device 100 creates the network slice, e.g. the first network slice and/or the second network slice, in the transport part of the network.

In an embodiment, the network slice control device 100 creates the network slice, e.g. the first network slice and/or the second network slice, in the core part of the network.

In an embodiment, the network slice control device 100 creates the network slice, e.g. the first network slice and/or the second network slice, for each of the RAN, core and transport part of the network.

In an embodiment, the network slice control device 100 that creates the network slice, e.g. the first network slice and/or the second network slice, configures or controls one or more of the following functions:
Differentiated handling of traffic for different network slices which have been pre-configured;
Detection of the RAN part of the network slice, by NSSAI provided by the UE or the 5G CN which unambiguously identifies one or more of the pre-configured network slices in the Public Land Mobile Network (PLMN);
Policy enforcement between slices as per service level agreements. It should be possible for a single network node 301 to support multiple slices. The network slice control device 100 may perform a Radio Resource Management (RRM) policy to each network slice.
QoS differentiation within the network slice, for example the first network slice and/or the second network slice;
RAN selection of CN entity:
In an embodiment, for initial attach, the first UE 201 provides NSSAI to support the selection of a CN node, for example AMF. If available, the network slice control device 100 uses this information for routing the initial NAS to an AMF. If the network slice control device 100 is unable to select an AMF using this information or the first UE 201 does not provide any such information the network slice control device 100 sends the NAS signalling to one of the default AMFs.
For subsequent accesses, the first UE 201 provides a Temp ID, which is assigned to the UE by the 5GC, to enable the NG-RAN to route the NAS message to the appropriate AMF as long as the Temp ID is valid (NG-RAN is aware of and can reach the AMF which is associated with the Temp ID). Otherwise, the methods for initial attach applies;
Resource isolation between network slices may, for example, be achieved by means of RRM policies and protection mechanisms that avoid that shortage of shared resources in one network slice breaks the service level agreement for another slice.

In an embodiment, the network slice control device 100 provides or allocates dedicated resources to the first network slice and/or the second network slice wherein the resources are compute, storage and/or networking resources.

In an embodiment, the network slice control device 100 provides or allocates the resources in a sharing manner, e.g. fair-sharing manner, with one or more other network slices, wherein the resources are compute, storage and/or networking resources.

The network slice control device 100 may, based on the affected network components, communicate with the necessary management entities of the mobile network operator's network, for example a cloud resource orchestrator or a transport intelligence function, for creating the network slice.

Hereby is achieved by the step 4:3, an on-demand, lightweight mechanism for creating a network slice which may be flexibly configured.

### Step 4:4 Associate the First Network Slice with the First Software and the Second Software

In an embodiment, the network slice control device 100 associates the first network slice with the first software 201 and the second software 202. More specifically, the network slice control device 100 associates the first network slice with at least one first UE 102 comprising the first software 201 and with the network node 301 comprising the second software.

In an embodiment, the network slice control device 100 associates the first network slice created above in Step 4:3 with the first software 201 and the second software 202.

In an embodiment, the network slice control device 100 associates the first network slice with the first software 201 and the second software 202 using at least one NSI.

In an embodiment, the network slice control device 100 associates the first network slice with the first software 201 and the second software 202 using at least one NSSI.

In an embodiment, the network slice control device 100 associates the first software 201 and the second software 202 with the first network slice at Protocol Data Unit/Packet Data Unit (PDU) session level, by indicating the S-NSSAI corresponding to the PDU Session. In an embodiment, the PDU Session belongs to one specific NSI per PLMN.

In an embodiment, the network slice control device 100 associates the first network slice with the first software 201 and the second software 202 at a Quality of Service (QoS) flow level. In this case, a PDU session belongs to multiple network slices.

### Step 4:5 Associate First Network Slice with a Third Software

In an embodiment, the network slice control device 100 associates the first network slice with a third software 203. The third software 203 allocates one or more common resources to the second software 202 in a fair sharing manner.

The network slice control device 100 may associate the first network slice with a third software 203 according to any of the methods described above in Step 4:4.

In an embodiment, the network slice control device 100 associates the first network slice created in step 4:3 with the third software 203.

In an embodiment, the network slice control device 100 associates the first network slice with the first software 201, the second software and the third software 203.

In an embodiment, the third software 203 comprises a scheduler to schedule the common resources to the first network slice.

In an embodiment, the third software 203 allocates one or more resources to the second software 202 and/or the first network slice in a fair sharing manner. The fair sharing may, for example, refer to allocating resources in a manner dependent on the functions being performed by the first software 201 and/or the second software 202. For instance, higher number of resources may be scheduled for computationally-intensive functions that need to be tested out in the UE, for example the first UE 102, and/or the network node 301/gNB 104. Such computationally-intensive functions may, for example, be encryption or decryption, video encoding, decoding or transcoding, augmented reality (AR) or artificial intelligence (AI) related networking tasks. On the other hand, lower number of resources may be scheduled in case computationally less intensive functions are being tested in the first UE 102. Such examples may include simple packet forwarding, basic QoS classification or radio bearer selection. The resources may be scheduled in a dynamic manner. The resources may either be dedicated and/or shared resources, for example in terms of function, processing power, storage, and bandwidth.

The allocation of resources in a fair-sharing manner may refer to allocating common resources to the first network slice of the first UE 102 and/or the second network slice of the second UE 103 such that the performance of testing a function in the first UE 102 is not adversely impacted when compared with the performance of testing the function in the second UE 103, due to the unfair allocation of common resources from the third software in favor of the one of the two UEs, e.g. in favor of the second UE 103. In other words, the common resources are allocated to the first network slice and/or the second network slice in an equally favorable manner for performing or executing a function to be tested in the communication network.

In an embodiment, the third software 203 allocates one or more common resources to the first software 201 in a fair sharing manner.

In an embodiment, the third software 203 allocates one or more common resources to the first network slice associated with the first software 201 in a fair sharing manner.

In an embodiment, the third software 203 allocates one or more common resources to the fourth software 204 in a fair sharing manner.

In an embodiment, the third software 203 allocates one or more common resources to the second network slice associated with the fourth software 204 in a fair sharing manner.

In an embodiment, the third software 203 allocates one or more common resources between the first network slice and the second network slice in a fair sharing manner.

In any of the above embodiments, the fair sharing may be implemented using weighted fair-queuing (WFQ) or in some embodiments, guaranteed bitrate (GBR) scheduling. It may be noted that WFQ can be implemented in various ways for example, multi-queue or core-stateless designs.

In an embodiment, the common resources are at least one of: compute, network, storage, bandwidth and spectrum.

### Step 4:6 Create a Second Network Slice

The network slice control device 100 creates a second network slice. The procedure for creating the second network slice is similar to those described above in relation to step 4:3. The methods described therein apply mutatis mutandis to this step.

However, it may be noted that the second network slice is created for one or more second UEs 103 in the communication network 110,112.

In an embodiment, the one or more second UEs 103 do not comprise the first software 201. In other words, while the one or more first UEs 102 comprise the first software 201 that is to be tested in the communication network 110, 111 and are thus programmed accordingly, the second UEs 103 may not be programmed with the first software 201.

In an embodiment, the one or more second UEs 103 comprise a previous version of the first software 201. In other words, the one or more second UEs 103 comprise the network stack as described above in relation to FIG. 2 and/or FIG. 3, but the network stack in the second UE 103 is of a previous version compared to the first software 201 and/or the network stack comprised in the first software 201.

### Step 4:7 Associate the Second Network Slice with a Fourth Software and the Second Ue

The network slice control device 100 associates the second network slice with a fourth software 204 and the second UE 103. In some embodiments, the fourth software 204 is comprised in the same network node 301 as the one comprising the network slice control device 100 and the second software 202. In some other embodiments, the fourth software 204 is comprised in a network node 301 different than the one comprising the network slice control device 100. In some embodiments, the fourth software is comprised in a separate network node 301 than the one comprising the second software 202. The procedure for associating the second network slice is similar to those described above in relation to arrow 4:4. The methods described therein apply mutatis mutandis to this step. It may further be noted that, in at least some embodiments, the second network slice is associated with a legacy software or a legacy network stack comprised in the second UE 103. The legacy software or the legacy network stack may, for example, refer to a software including and/or executing the 3GPP Rel 16 specification functions. Such legacy software may typically not include and/or not execute functions related to UE programmability for example, as described herein.

### Step 4:8 Associate the Second Network Slice with the Third Software

The network slice control device 100 associates the second network slice with the third software 203. The third software 203 assigns the common resources between the second software 202 and the fourth software 204 in a fair sharing manner. The procedure for associating the second network slice is similar to those described above in relation to the step 4:5. The methods described therein apply mutatis mutandis to this step.

It may further be noted that, in an embodiment, the third software allocates the one or more common resources between the first network slice associated with the second software and the second network slice associated with a fourth software.

In a further embodiment, the first network slice and the second network slice are both associated with the third software. The third software 203 assigns the common resources between the first network slice and the second network slice in a fair sharing manner.

### Optional Steps 4:9 to 4:10—Send Function for Testing

As illustrated in FIG. 4 by arrow Step 4:9, the network slice control device 100 sends to at least one first UE 102, a function for testing. Similarly, as illustrated in FIG. 4 by arrow Step 4:10, the network slice control device 100 sends to at least one second UE 103, a function for testing. In other words, the network slice control device 100 sends to at least one first UE 102 and/or at least one second UE 103 an indication of which function is to be tested. The indication indicates to the UEs (such as the first UE 102) which of the functions enabled by their software (such as the first software 201) is to be tested.

The indication may, for example, be included in message such as an RRC message. The indication may, for example, be included in any arbitrary, non-standard message that is part of the network stack deployment procedure to the UE, e.g. the first UE 102, and/or the network node 201.

The function may be a functionality to be tested in the communication network 110,111.

The function may refer to one or more functions comprised in the first software 201 that is deployed in the first UE 102 as described in step 4:1.

The function to be tested may for example, be at least one of: packet scheduling, radio slot allocation, cell selection, quality of service enforcement, routing, packet inspection, service identification.

### Optional Steps 4:11 to 4:12—Receiving Data Related to Function

At least one first UE 102 and at least one second UE 103 perform the one or more functions in the communication network 110, 111, 112 based on the instructions sent by the network slice control device 100 respectively.

As illustrated by Step 4:11, the network slice control device 100 receives from at least one first UE 102 data related to the function tested in the communication network.

As illustrated by Step 4:12, the network slice control device 100 receives from at least one second UE 103 data related to the function tested in the communication network.

The communication of messages between the network slice control device 100 and the first UE 102/the second UE 103 may, for example, be based on apt command framework from Ubuntu or any other mobile-specific OTA mechanisms. The communication of messages between the network slice control device 100 and the first UE 102/the second UE 103 may, for example, be based on 3GPP Standard protocols.

The data may, for example, include KPIs related to network such as latency, round-trip time, throughput, signal strength(s), radio resource utilization.

The network slice control device 100 may thus perform testing of one or more functions in the communication network.

The testing may, for example, include
obtaining at least one KPI from at least one first UE 102 and at least one second UE 103;
comparing the KPI of the first UE 102 with the KPI of the second UE 103;
analyzing the operation of the first software 201 or the network stack deployed in the first UE 102.

The analyzing may for example further include determining if the first software 201 is suitable for being deployed in all UEs of the communication network.

While in some embodiments the network slice control device 100 performs the testing of one or more functions, in some other embodiments the testing of one or more functions is performed in a network management node or a network node for performance monitoring. In yet some other embodiments, the second software 202 comprising the network stack performs the testing of one or more functions.

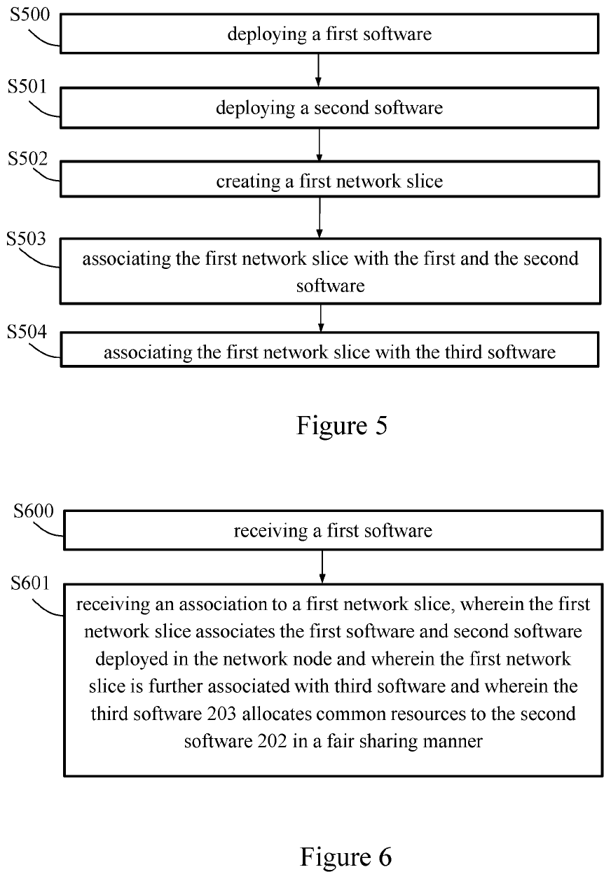

FIG. 5 illustrates a method performed by a network slice control device 100 for testing one or more functions in a communication network 110,111,112. The network 110,111,112 comprises common resources for communication between a network node 100, 101, 104, 301 and at least a UE 102, 103 according to an embodiment. The method comprises:
At step S500, deploying a first software 201 in at least one first UE 102;
At step S501, deploying a second software 202 in the network node;
At step S502, creating a first network slice;
At step S503, associating the first network slice with the first software 201 and associating the first network slice with the second software 202; and
At step S504, associating the first network slice with a third software 203, wherein the third software 203 allocates common resources to the second software 202 in a fair sharing manner.

As can be seen from FIG. 4 above, step 4:1 of FIG. 4 is an example of the step S500 of FIG. 5. Similarly, step 4:2 of FIG. 4 is an example of the step S501 of FIG. 5. Further, step 4:3 of FIG. 4 is an example of the step S502 of FIG. 5. Still further, step 4:4 of FIG. 4 is an example of the step S503 of FIG. 5. Yet still further, step 4:5 of FIG. 4 is an example of the step S504 of FIG. 5.

Optionally, in an embodiment, the method in FIG. 5 comprises creating a second network slice. Step 4:6 of FIG. 4 is an example of this previous method step. The method in FIG. 5 may further comprise associating the second network slice with a fourth software 204 and associating the second network slice with at least one second UE 103. Step 4:7 of FIG. 4 is an example of this previous method step. Finally, the method in FIG. 5 may comprise associating the second network slice with the third software 203 wherein the third software 203 assigns the common resources between the second software 202 and the fourth software 204 in a fair sharing manner.

Optionally, in an embodiment, the method in FIG. 5 comprises performing at least one of the steps 4:9 to 4:12 described above in the relation to FIG. 4.

FIG. 6 illustrates a method performed by a first UE 102 for testing one or more functions in a communication network 110, 111, 112. The network 110, 111, 112 comprises common resources for communication between a network node 100, 101, 104, 301 and UEs 102, 103 according to an embodiment. The method comprises:
At step S600, receiving first software 201 from the network node 301;
At step S601, receiving an association to a first network slice. The first network slice associates the first software 201 and second software 202 deployed in the network node 301. The first network slice is further associated with third software 203.The third software 203 allocates common resources to the second software 202 in a fair sharing manner.

Step S600 is an example of step 4:1 of FIG. 4, but, from the perspective of the first UE 102. In an embodiment, the receiving of step S600 further comprises installing the first software 201 in the first UE 102. The first software 201 may be installed according to standard procedures for installing a software received via OTA mechanism. Further, step S601 is an example of step 4:4 of FIG. 4, but, from the perspective of the first UE 102.

Optionally, in an embodiment, the method further comprises performing at least one of the steps 4:9 to 4:12 described above in the relation to FIG. 4.

Referring to FIG. 5 and FIG. 6, the network node is at least one of the following: the network slice control device 100, the BS 101, the gNB 104 and the network node 301.

Referring to FIG. 5 and FIG. 6, it may be noted that, in some embodiments, the first software 201 and the second software 202 both comprise the same software version or the same version of the network stack that is deployed. In other words, the first software 201 and the second software 202 execute the same versions of the software or the network stack.

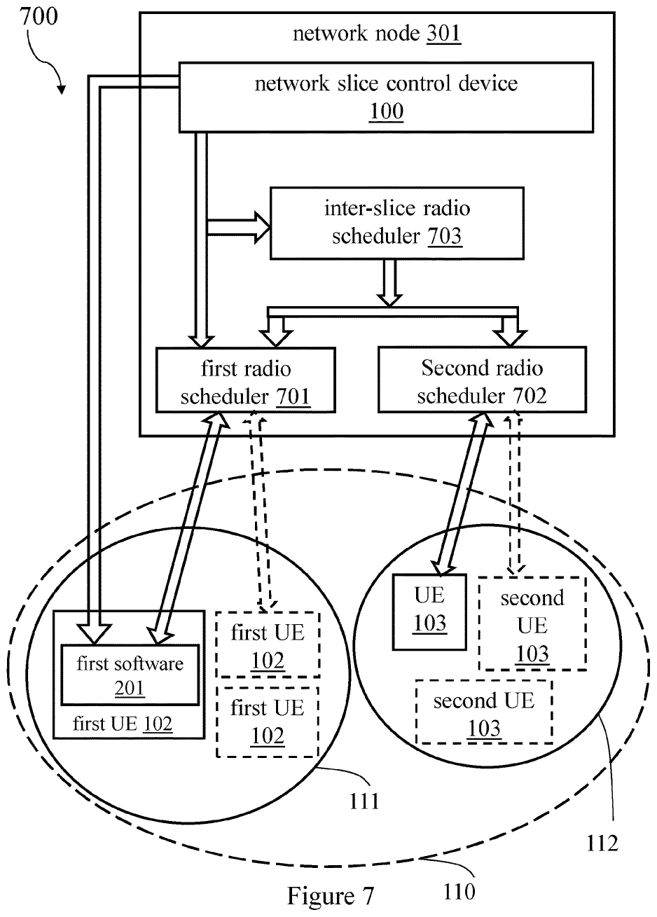

FIG. 7 illustrates a system 700 according to an embodiment. In this embodiment, the network node 301 comprises a network slice control device 100, a first radio scheduler 701, a second radio scheduler 702 and an inter-slice radio scheduler 703. The system 700 further comprises at least one first UE 102 and at least one second UE 103 operating in a communication network 110, 111, 112. The first UE 102 comprises the first software 201.

Comparing FIG. 7 to FIG. 1a, the second software 202 from FIG. 1a is a radio scheduler, for example the first radio scheduler 701. Further, the fourth software 204 from FIG. 1a is a radio scheduler, for example the second radio scheduler 702. Furthermore, the third software 203 from FIG. 1a is a radio scheduler, for example the inter-slice radio scheduler 703 that schedules one or more common resources between the first radio scheduler 701 and the second radio scheduler 702 in a fair sharing manner.

It may further be noted that the network slice control device 100 associates a first network slice between the first software 201, the first radio scheduler 701 and the inter-slice scheduler 703. The network slice control device 100 associates a second network slice between the second UE 103, the second radio scheduler 702 and the inter-slice scheduler 703.

In an embodiment, the inter-slice radio scheduler 703 allocates one or more resources based on one or more of the following:
UE buffer status;
QoS requirements of each UE, for example the first UE 102;
QoS requirements of radio bearers associated with each UE;
radio conditions at the UE identified through measurements made at the gNB and/or reported by the UE.

The one or more resources may, for example, be a radio resource such as radio spectrum, frequency, resource blocks. The one or more resources may, for example, be compute, storage and/or network resources.

The resources may either be dedicated and/or shared resources, for example in terms of function, processing power, storage, and/or bandwidth.

It will be appreciated that methods described above in relation to FIG. 4 may also apply to the embodiment according to FIG. 7.

### Network Slicing Concepts

Network slicing is a concept to allow differentiated treatment depending on each customer requirements. With slicing, it is possible for mobile network operators (MNO) to consider customers as belonging to different tenant types with each having different service requirements that govern in terms of what slice types each tenant is eligible to use based on Service Level Agreement (SLA) and subscriptions.

A network slice, for example the first network slice and/or the second network slice, is a logical network that provides specific network capabilities and network characteristics. The network slice could span across multiple network domains, for example access network, core network and transport network. The network slice includes dedicated and/or shared resources, for example in terms of function, processing power, storage, and bandwidth. Dedicated resources can be isolated from other network slices. A network slice available in the HPLMN to their own subscribers, may also be available when the UE is roaming.

A network slice, for example the first network slice and/or the second network slice, may, for example, comprise logical layers such as:
Service Instance Layer that hosts the services or applications provided to the end user.
NSI Layer that represents a collection of resources from the resource layer to form a network slice.
Resource Layer that hosts different subnetwork instances. Each subnetwork instance or NSSI represents a network, computation, and storage resource, typically, as one or a group of Virtual Network Functions (VNFs) or Physical Network Functions (PNFs).

Each network slice, for example the first network slice and/or the second network slice, may be uniquely identified by a Single Network Slice Selection Assistance Information (NSSAI), as defined in for example, 3GPP TS 23.501 Rel 17 v17.4.0 (2022 Mar. 23). NSSAI includes one or a list of Single NSSAIs (S-NSSAIs) where a S-NSSAI is a combination of:
mandatory SST (Slice/Service Type) field, which identifies the slice type and consists of 8 bits (with range is 0-255);
optional SD (Slice Differentiator) field, which differentiates among Slices with same SST field and consist of 24 bits.

In an embodiment, the list includes at most eight S-NSSAIs. In an embodiment, the list includes at least one S-NSSAIs. While the communication network 110 can support large number of slices, for example few hundreds, the UE need not support more than eight slices simultaneously.

In an embodiment, the first UE 102 sends to the network node 301, the NSSAI for the network slice selection in a RRCSetupComplete message.

Network slices may differ for supported features and network functions optimisations, in which case such network slices may have for example different S-NSSAIs with different Slice/Service Types.

An MNO or the network slice control device 100 may create and deploy multiple network slices delivering exactly the same features but for different groups of UEs, for example as they deliver a different committed service and/or because they are dedicated to a customer. In such cases, the network slices may have for example different S-NSSAIs with the same Slice/Service Type but different Slice Differentiators.

The network or the network slice control device 100 may serve at least one UE, for example the first UE 102, with one or more NSIs simultaneously via a 5G Access Network regardless of the access type over which the UE is registered (i.e. 3GPP Access and/or N 3GPP Access).

An NSI is defined within a PLMN or within an Stand-alone Non-Public Network (SNPN) and includes the core network CP and UP Network Functions, as described in, for example, 3GPP TS 23.501 Rel 17 v17.4.0 (2022 Mar. 23).

In the serving PLMN, the NSI includes at least one of the following functions:
the NG-RAN;
the N3IWF or TNGF functions to the non-3GPP Access Network described in, for example, 3GPP TS 23.501 Rel 17 v17.4.0 (2022 Mar. 23) or the TWIF functions to the trusted WLAN in the case of support of N5CW devices described in, for example, 3GPP TS 23.501 Rel 17 v17.4.0(2022 Mar. 23);
the W-AGF function to the Wireline Access Network described in, for example, 3GPP TS 23.501 Rel 17 v17.4.0 (2022 Mar. 23).

A NSI may comprise none, one, or more NSSIs, which may be shared with another NSI. The NSSI, in turn, is formed of a set of NFs, which can be either VNFs or PNFs. A communication service typically uses one NSI.

A NSI can be associated with one or more S-NSSAIs, and an S-NSSAI can be associated with one or more NSIs. Multiple NSIs associated with the same S-NSSAI may be deployed in the same or in different Tracking Areas. When multiple NSIs associated with the same S-NSSAI are deployed in the same Tracking Areas, the AMF instance serving the UE may logically belong to (i.e. be common to) more than one NSIs associated with this S-NSSAI.

In a PLMN, when an S-NSSAI is associated with more than one NSI, one of these NSIs, as a result of the NSI selection procedure, serves a UE that is allowed to use this S-NSSAI. For any S-NSSAI, the network may at any one time serve the UE with only one Network Slice instance associated with this S-NSSAI until cases occur where for example this Network Slice instance is no longer valid in a given Registration Area, or a change in UE's Allowed NSSAI occurs, etc.

A network slice (for example a network slice created by the network slice control device 100) may be fully or partly, logically and/or physically, isolated from another network slice/network slice instance.

In an embodiment, the network slices are physically separated, for example different rack, different hardware, different location, etc.

In an embodiment, the network slices are isolated based on operating system processes and threads.

In an embodiment, the network slices are isolated based on physical memory isolation.

In an embodiment, the network slices are isolated based on physical storage isolation.

In an embodiment, the network slices are isolated based on physical network isolation.

In an embodiment, the network slices are isolated based on are logical separation.

In an embodiment, the network slices are isolated based on virtual resources isolation. For instance, a network slice may have access to specific range of resources that do not overlap with other network slices (for example VM isolation).

In an embodiment, the network slices are isolated based on network function (NF) isolation. For example, the NF is dedicated to the NSC, but virtual resources are shared.

In an embodiment, the network slices are isolated based on Tenant/Service Isolation. For example, the NSC data are isolated from other NSCs, but virtual resources and NFs are shared.

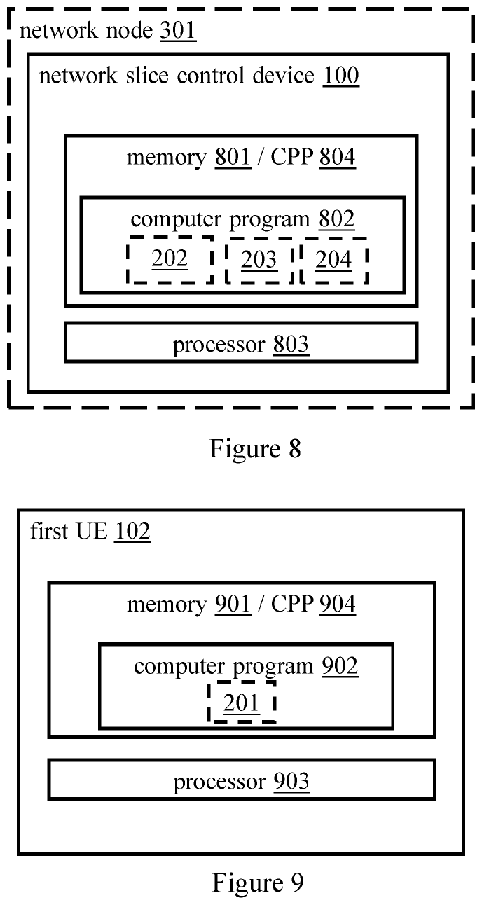

Referring to FIG. 8, the network slice control device 100 according to FIG. 8 may have storage and/or processing capabilities. The network slice control device 100 may be configured to control any of the methods and/or processes described herein and/or to cause such methods, and/or processes to be performed. Processor 803 corresponds to one or more processors for performing network slice control device 100 functions described herein. The network slice control device 100 includes memory 801 or computer readable storage medium 801 that is configured to store data, programmatic software code and/or other information described herein. In particular, in addition to a traditional processor and memory, the network slice control device 100 may comprise integrated circuitry for processing and/or control, for example, one or more processors and/or processor cores and/or FPGAs (Field Programmable Gate Array) and/or ASICs (Application Specific Integrated Circuitry) adapted to execute instructions. The processor(s) 803 may be configured to access, for example, write to and/or read from the memory 801 or the computer readable storage medium 801, which may comprise any kind of volatile and/or nonvolatile memory, for example, cache and/or buffer memory and/or RAM (Random Access Memory) and/or ROM (Read-Only Memory) and/or optical memory and/or EPROM (Erasable Programmable Read-Only Memory).

The memory 801 or the computer readable storage medium 801 may include instructions which, when executed by the one or more processors 803, cause the network slice control device 100 to perform the processes described herein with respect to the network slice control device 100, for example method(s) described in relation to FIG. 5. The instructions may be software (SW) or a computer program associated with the network slice control device 100.

Thus, the network slice control device 100 may further comprise SW or a computer program, which is stored in, for example, the memory 801 or the computer readable storage medium 801 at the network slice control device 100, or stored in external memory, for example, database, accessible by the network slice control device 100. The SW or computer program may be executable by the one or more processors 803. The network slice control device 100 may comprise the second software 202, the third software 203 and the second software 204 as described herein according to one or more embodiments.

Further, the network slice control device 100 may be comprised in a network node 301 or operate independently in a separate node.

A computer program product (CPP) 804 in the form of a computer readable storage medium 801 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media, for example, a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 803. Computer readable storage medium 801 may store any suitable instructions, data or information, including a computer program, software, an application including one or more of logic, rules, code, tables, etc. and/or other instructions capable of being executed by one or more processors 803. Computer readable storage medium 801 may be used to store any calculations made by one or more processors 803. In some embodiments, one or more processors 801 and the memory/computer readable storage medium 801 may be considered to be integrated.

Referring to FIG. 9, the first UE 102 according to FIG. 9 may have storage and/or processing capabilities. The first UE 102 may be configured to control any of the methods and/or processes described herein and/or to cause such methods, and/or processes to be performed. Processor 903 corresponds to one or more processors for performing first UE 102 functions described herein. The first UE 102 includes memory 901 or computer readable storage medium 901 that is configured to store data, programmatic software code and/or other information described herein. In particular, in addition to a traditional processor and memory, the first UE 102 may comprise integrated circuitry for processing and/or control, for example, one or more processors and/or processor cores and/or FPGAs (Field Programmable Gate Array) and/or ASICs (Application Specific Integrated Circuitry) adapted to execute instructions. The processor(s) 903 may be configured to access, for example, write to and/or read from the memory 901 or the computer readable storage medium 901, which may comprise any kind of volatile and/or nonvolatile memory, for example, cache and/or buffer memory and/or RAM (Random Access Memory) and/or ROM (Read-Only Memory) and/or optical memory and/or EPROM (Erasable Programmable Read-Only Memory).

The memory 901 or the computer readable storage medium 901 may include instructions which, when executed by the one or more processors 903, cause the first UE 102 perform the processes described herein with respect to the first UE 102, for example method(s) described in relation to FIG. 6. The instructions may be software (SW) or computer program associated with the first UE 102.

Thus, the first UE 102 may further comprise software or a computer program, which is stored in, for example, the memory 901 or the computer readable storage medium 902 at the first UE 102, or stored in external memory, for example, database, accessible by the first UE 102. The SW or computer program may be executable by the one or more processors 903. The first UE 102 may comprise the first software 201 as described herein according to one or more embodiments.

A computer program product (CPP) 904 in the form of a computer readable storage medium 901 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media, for example, a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 903. Computer readable storage medium 901 may store any suitable instructions, data or information, including a computer program, software, an application including one or more of logic, rules, code, tables, etc. and/or other instructions capable of being executed by one or more processors 903. Computer readable storage medium 901 may be used to store any calculations made by one or more processors 903. In some embodiments, one or more processors 903 and the memory/computer readable storage medium 901 may be considered to be integrated.

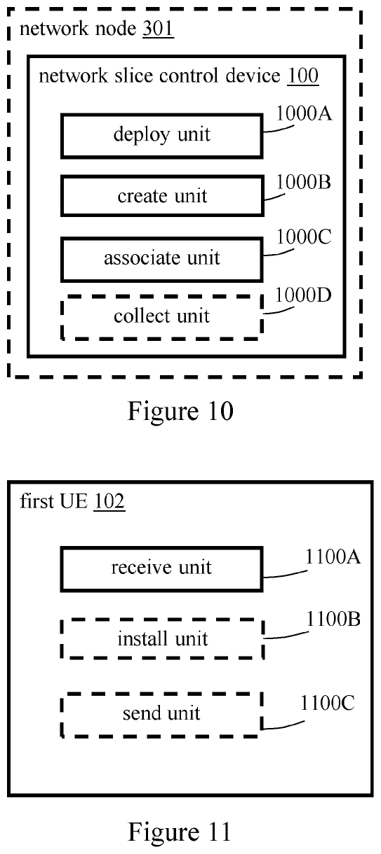

Referring to FIG. 10, in general terms, each functional unit 1000A, 1000B, 1000C and 1000D, i.e. the deploy unit 1000A, the create unit 1000B, the associate unit 1000C, and optionally, the collect unit 1000D, may be implemented in hardware or in software. Preferably, one or more or all functional units 1000A-1000D may be implemented by the one or more processors 803, possibly in cooperation with the computer readable storage medium 801 or the memory 801. The one or more processors 803 may thus be arranged to fetch instructions, from the computer readable storage medium 801 or the memory 801, as provided by a functional unit 1000A-1000D and to execute these instructions, thereby performing any steps of the network slice control device 100 as disclosed herein, for example steps disclosed in relation to FIG. 5. More specifically, in an embodiment, the deploy unit 1000A is configured to perform steps S500 and S501 of FIG. 5. Further, the create unit 1000B is configured to perform step S502 of FIG. 5. Furthermore, the associate unit 1000C is configured to perform the steps S503 and S504 of FIG. 5. In an embodiment, to collect unit 1000D is configured to collect key performance index, KPI, data from the first UE 102 and the second UE 103.

Referring to FIG. 11, in general terms, each functional unit 1100A, 1100B, and 1100C i.e. the receive unit 1100A, the install unit 1100B (optional unit), and the send unit 1100C (optional unit), may be implemented in hardware or in software. Preferably, one or more or all functional units 1100A-1100C may be implemented by the one or more processors 903, possibly in cooperation with the computer readable storage medium 901 or the memory 901. The one or more processors 903 may thus be arranged to fetch instructions, from the computer readable storage medium 901 or the memory 801, as provided by a functional unit 1100A-1100C and to execute these instructions, thereby performing any steps of the first UE 102 as disclosed herein, for example steps disclosed in relation to FIG. 6. More specifically, in an embodiment, the receive unit 1100A is configured to perform steps S600 and S601 of FIG. 6. In an embodiment, the install unit 1100B is configured to install the first software 201 in the first UE 102. In an embodiment, the send unit 1110C is configured to send, to the network node, KPI data associated with the first UE 102 that is using the first software 201.

1. A method performed by a network slice control device for testing a function in a communication network the communication network comprising common resources for communication between a network node and user equipments, UEs, the function being associated with one or more of the UEs, the method comprising:
deploying, for testing the function, first software in a first UE and second software in the network node;
creating a first network slice;
associating the first network slice with the first software and the second software;
associating the first network slice with third software;
creating a second network slice;
associating the second network slice with fourth software and a second UE; and
associating the second network slice with the third software, the third software allocating common resources between the second software and the fourth software in a fair sharing manner.

2. (canceled)

3. The method according to claim 1, comprising collecting key performance index, KPI, data from the first UE and the second UE, wherein the KPI data includes at least one of: latency, round-trip time, throughput, signal strength(s) and radio resource utilization.

4. (canceled)

5. The method according to claim 1, wherein deploying the first software includes sending a new instance of a network stack or configuring an existing instance of a network stack, wherein the network stack includes the function to be tested.

6. The method according to claim 1, wherein the function includes at least one of: packet scheduling, radio slot allocation, cell selection, quality of service enforcement, routing, packet inspection and service identification.

7. The method according to claim 1, wherein the deploying of the first software is carried out using Over-The-Air software update.

8. The method according to claim 1, comprising testing the function, wherein the testing includes:
obtaining a KPI, for the first UE and a KPI for the second UE; and
evaluating performance of the first software based on the obtained KPIs.

9. The method of claim 8, wherein evaluating performance of the first software comprises evaluating performance of the function.

10. The method according to claim 1, wherein the third software is a radio scheduler that allocates common resources between the second software and fourth software in a fair sharing manner, wherein the second software is a radio scheduler for scheduling radio resources for testing the function and the fourth software is a radio scheduler pre-configured to schedule radio resources for a second UE.

11. The method according to claim 1, wherein the fair sharing of the common resources is performed using Weighted Fair Queuing, WFQ.

12. The method according to claim 1, wherein the common resources comprise at least one of the radio resources: resource block, bandwidth and frequency.

13. The method according to claim 1, wherein the common resources comprise at least one of: a computing resource, a network resource and a storage resource.

14.-25. (canceled)

26. A network slice control device for testing a function in a communication network, the communication network comprising common resources for communication between a network node and user equipments, UEs, the function being associated with one or more of the UEs, the network slice control device comprising a memory and a processor, the memory containing instructions which when executed on the processor cause the network slice control device to:
deploy, for testing the function, first software in a first UE and second software in the network node;
create a first network slice;
associate the first network slice with the first software and the second software;
associate the first network slice with third software;
create a second network slice;
associate the second network slice with fourth software and a second UE; and
associate the second network slice with the third software, the third software allocating common resources between the second software and the fourth software in a fair sharing manner.

27. -56. (canceled)

57. The network slice control device according to claim 12, the memory containing instructions which when executed on the processor further cause the network slice control device to collect key performance index, KPI, data from the first UE and the second UE, wherein the KPI data includes at least one of: latency, round-trip time, throughput, signal strength(s) and radio resource utilization.
